(19) United States
(12) Patent Application Publication
(10) Pub. No.: US 2019/0072219 A1
(43) Pub. Date: Mar. 7, 2019

(54) Coupling kit to quickly attach and detach a safety whip mast to an off-road vehicle and prevent the mast from rotating.

(71) Applicant: Andrew Anderson, Hesperia, CA (US)

(72) Inventor: Andrew Anderson, Hesperia, CA (US)

(21) Appl. No.: 15/697,411

(22) Filed: Sep. 6, 2017

(51) Int. Cl. F16L 37/23; B62J 99/00

(52) U.S. Cl. CPC F16L 37/23; B62J 2099/008; B62J 99/00

(57) ABSTRACT

The coupling kit disclosed herein to attached a mast used by off-road vehicles to the frame of the off-road vehicle provides three advantages not seen in prior art. The first advantage is that of the two components of a coupling kit one is an off-the-shelf product thus reducing the cost of manufacture. The second is that the coupling kit allows for damaged or broken masts to be quickly replaced without the use of tools by another mast or that masts may be easily transferred from one off-road vehicle to another. The third is that the coupling kit does not allow the mast to rotate about its longitudinal axis.

### BACKGROUND OF THE INVENTION

### 1. Field of the Invention

The present invention relates to a connection system for use in joining a safety whip mast to an off-road vehicle so that the safety whip mast may be quickly coupled and uncoupled to the off-road vehicle and does not allow the safety whip mast to rotate about its longitudinal axis.

### 2. Description of the Related Art

Individuals who enjoy the outdoor sport of “off-roading” often attach a mast to their off-road vehicle that extends well above their vehicle to allow others, who may be driving an off-road vehicle nearby, to know the whereabouts of their location. The use of a mast extending above their vehicles to denote their presence promotes the safety of the driver and passengers of the off-road vehicle during the day by attaching a brightly colored flag or pennant to the top of the mast or during the night by attaching to the mast an array of light emitting diodes (LEDs) that is powered by electrical energy supplied by the off-road vehicle or some other electrical power source such as a battery.

Although beneficial as a means for quick identification of the presence of an off-road vehicle, the mast does create a problem in that they break. Although masts are to a great degree flexible, they must extend some height above the off-road vehicle to give the off-road vehicle some degree of visibility. As such, masts are subject to shearing forces when the off-road vehicle is driven underneath rock outcroppings or trees as well as when driving by bushes. These forces may cause the mast to snap and require a replacement mast to be attached to the off-road vehicle. Attachment of a replacement mast must be done quickly to allow the participants to return back to the sport of off-roading and with minimal to no tooling as the locale is very likely to be remote. Quick connect type of couplers are ideal for such a situation and provides the added benefits of easily removing the mast when transporting the off-road vehicle or transferring a mast from one off-road vehicle to another.

Quick connect couplers are basically comprised of two components. The first component is a cylindrically shaped coupler body while the second component is a cylindrically shaped plug. At one end of the coupler body is found a means of attaching the coupler body to a point on the frame of the off-road vehicle. Typically, some sort of threading is used to connect the coupler body to a corresponding threaded mount on the frame of the off-road vehicle. At the opposing end of the coupler body is an opening that receives the plug and employees a ball-lock system to lock the plug into the coupler body. As for the plug, an end containing a groove about its circumference is inserted into the coupler body while the opposite end is open to receive a mast. For a ball-lock system the coupler body has one or more holes about the opening. These holes are covered by a spring-loaded sleeve and within each hole is a ball. The holes are tapered or stepped to reduce their diameter at the opening so the balls do not fall into the opening but partially protrude into the opening when the spring-loaded sleeve is in its normal closed position. It is not possible to insert the plug when the spring-loaded sleeve is in its closed position. When pulling back on the spring-loaded sleeve the wall becomes thinner thereby increasing the gap between the ball and the wall of the spring-loaded sleeve so that the ball may roll into this gap and no longer protrude into the opening. Once the spring-loaded sleeve has been pulled back the plug may be inserted into the opening deep enough so that the groove present on the plug is opposite the one or more holes. Releasing the spring-loaded sleeve back to its normally closed position caused the balls to protrude back into the opening and into the groove present on the plug. At this point the plug is locked into the coupler body and may not be removed until the spring-loaded sleeve is pulled back to allow the balls to roll away from the opening.

There are many patents that relate to quick coupling devices. US patent publication 2013/0186494 discloses a quick connect coupler that cuts the flow from the coupler body to the plug when a certain temperature is reached. US patent publication 2016/0138744 discloses a quick connector coupler with a design that simplifies the manufacturing and cleaning of the coupler body. US patent publication 2014/0116533 discloses a quick connect coupler where the coupler body is capable of forming a connection with a variety of plugs thus being called a “universal” coupler. While each of these quick coupling devices, as well as many others, allow the coupler body and the plug to quickly connect or to be disconnected they have a problem in that groove present on the plug allows the plug to rotate. In a rugged environment such as off-roading, the plug will rotate about its longitudinal axis due to the extensive amount of vibration present while the off-road vehicle travels over the terrain. When the plug rotates so will the mast rotate and will eventually start pulling on the electrical connectors supplying power to the array of LEDs and could cause a breakage in the electrical connector resulting in the array of LEDs failing to light.

Various patents have disclosed inventive concepts that prevent the plug from rotating about its longitudinal axis. U.S. Pat. No. 6,682,106 addresses this problem by adding anti-rotation flats on the plug that engage with anti-rotation tabs on the coupler body. Thus, when the plug has been properly connected to the body coupler the plug will not rotate independently of the body coupler. US patent publication 2008/0315581 discloses a plug with one or more ridges present in the groove that prevent further rotation of plug once a ridge comes up against a ball from the body coupler that protrudes within the opening that receives the plug. U.S. Pat. No. 7,083,120 discloses a spring-loaded sleeve where the opening through which the plug is inserted is hexagonal in shape to engage with a hexagonal surface present on the plug. When the plug has been connected to the body coupler the plug is prevented from rotating due to the engagement of the hexagonal surface of the plug and the hexagonal opening in the spring-loaded sleeve. While these patents and publications do prevent the plug from rotating they require that both the body coupler and the plug be of special manufacture. It would be preferred that only the plug be of special manufacture but still be able to utilize off the shelf body couplers. US patent publication 2008/0315581 achieves this goal by only requiring that the plug, having ridges in the groove, be of special manufacture. However, adding ridges to the groove is a delicate process and additional balls in the body coupler are needed to minimize the amount of rotational travel allowed by the plug.

Known systems do not provide a means to quickly couple and uncouple a mast to an off-road vehicle using an off-the-shelf body coupler along with a plug that is simple to manufacture.

### BRIEF SUMMARY OF THE INVENTION

The present invention to be disclosed herein is for a ball-lock quick connect coupler kit comprised of a coupler body and a plug.

The coupler body is generally cylindrical in shape with two ends. The first end of the coupler body is fastened to the frame of the off-road vehicle while the second end has an opening to receive the plug. The second end of the coupler body contains one or more balls positioned in holes located around the diameter of the opening. These holes are tapered or stepped to reduce their diameter at the opening so the balls do not fall into the opening but partially protrude into the opening. A spring-loaded sleeve about the second end of the coupler body firmly pushes against the balls so that the balls are protruding into the opening. Pulling back on the spring-loaded sleeve allow the balls to retract so that they no longer protrude into the opening. The body coupler operates much like other body couplers for quick connect kits and many of those many be used with the plug of the present invention.

The plug is also generally cylindrical in shape with two ends. The first end of the plug has one or more dimples about the diameter to engage the balls about the diameter of the body coupler's second opening when the plug is inserted into the coupler body. The second end of the plug has an opening to receive the mast. When the dimples about the diameter of the plug has engaged the balls within the body coupler the plug will not be allowed to rotate about its longitudinal axis.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

Neither this summary nor the following detailed description defines or limits the invention. The invention is defined by the claims.

### BRIEF DESCRIPTION OF DRAWINGS

The present invention will become more fully understood from the detailed description and accompanying drawings, wherein:

FIG. 1 shows a perspective view of the coupling kit consisting of both the body coupler and the plug.

FIG. 2 shows a perspective expanded view of the coupling kit's body coupler.

FIG. 3 shows a perspective cutaway view of the coupling kit's plug.

### DETAILED DESCRIPTION OF THE INVENTION

The coupling kit disclosed herein to attached a mast used by off-road vehicles to the frame of the off-road vehicle provides three advantages not seen in prior art. The first advantage is that of the two components of a coupling kit one is an off-the-shelf product thus reducing the cost of manufacture. The second is that the coupling kit allows for damaged or broken masts to be quickly replaced without the use of tools by another mast or that masts may be easily transferred from one off-road vehicle to another. The third is that the coupling kit does not allow the mast to rotate about its longitudinal axis. The following description of the preferred embodiment(s) is merely exemplary in nature and is in no way intended to limit the invention, its application, or uses.

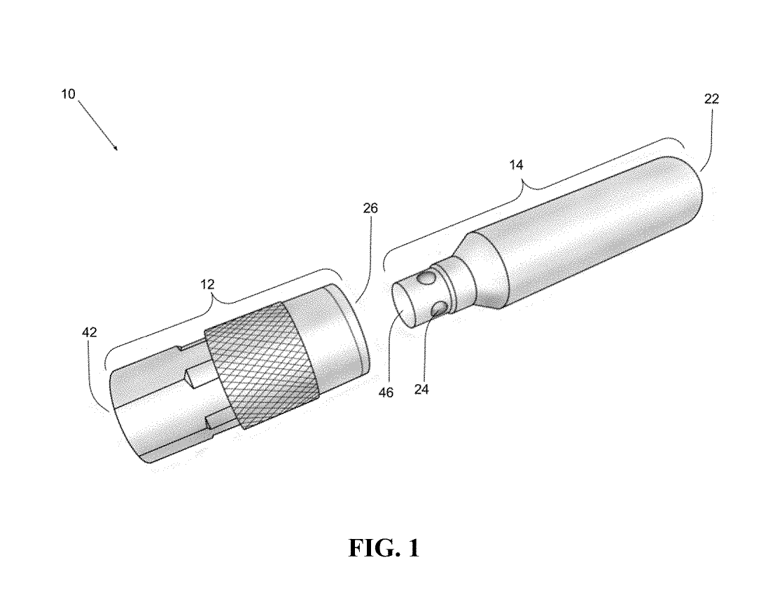

FIG. 1 shows coupling kit 10 and its two basic components, body coupler 12 and plug 14. The body coupler 12 is generally cylindrical in shape with first end 42 and second end 26. As shown in FIG. 1, first end 42 is of a female threaded type designed to be threaded onto a post mounted on the off-road vehicle containing a matching thread type. First end 42 of body coupler 12 may also be of a male threaded type designed to be threaded into a socket opening mounted on the off-road vehicle containing a matching thread type. For the remainder of this disclosure first end 42 will be shown as in FIG. 1 with the understanding that first end 42 may be of either female or male orientation. Body coupler 12 contains an opening at second end 26 wherein plug 14 is inserted. Plug 14 is generally cylindrical in shape with a first end 46 and second end 22. First end 46 of plug 14 contains one or more dimples 24 that engage locking mechanism found within second end 26 of body coupler 12 while second end 22 is open to receive the base of the mast.

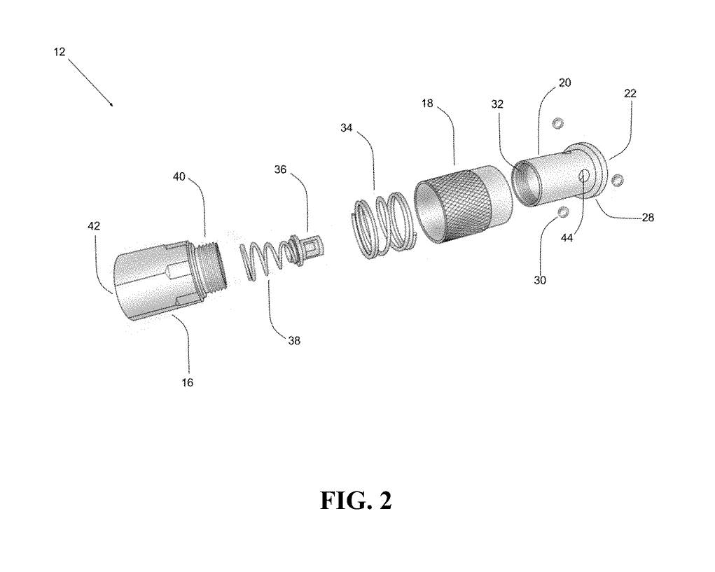

FIG. 2 shows the individual subcomponents that make up body coupler 12. The subcomponents are socket body 16, spiral spring 38, compression spring 34, tubular sleeve 18, and locking port 20. Socket body 16 first end 42 is the same as first end 42 of body coupler 12 and is received by a corresponding mount on the off-road vehicle. Male threaded portion 40 engages with female threaded portion 32 of locking port 20 to form a single combined unit with spiral spring 38 contained within. The base of spiral spring 38 sits on top of an annular flange within socket body 16 while the base of push head 36 engages an annular flange within locking port 20 such that the remainder of push head 36 continues to protrude further into locking port 20. Prior to engaging socket body 16 with locking port 20, tubular sleeve 18 is slipped over the outside of locking port 20 and may freely move across the surface of body coupler 12. When tubular sleeve 18 is moved towards socket body 16 locking balls 30 may partially roll out of holes 44 allowing first end 46 of plug 14 to enter into locking port 20. When tubular sleeve 18 is moved towards locking port 20, locking balls 30 are forced back into holes 44 and protrude within the opening of locking port 20. Holes 44 are tapered so that locking balls 30 do not fall into opening 22. Normally tubular sleeve 18 is to be positioned towards locking port 20. Compression spring 18, inserted between locking port 20 and tubular sleeve 18, biases tubular sleeve 18 towards locking port 20.

To engage body coupler 12 and plug 14 tubular sleeve 18 must be moved towards socket body 16 with sufficient force to overcome compressions spring 18. In this position locking balls 30 that were protruding into the opening of locking port 20 may be pushed out by the entry of first end 46 of plug 14. As first end 46 of plug 14 is inserted into locking port 20 push head 36 is engaged and additional force is required to overcome spiral spring 38 so that dimples 24 are aligned with holes 44. At this point tubular sleeve 18 may be released and compression spring 34 will bias tubular sleeve towards locking port 20 forcing locking balls 30 to engage with dimples 24. Once locking balls 30 have engaged dimples 24 plug 14 may not be removed from body coupler 12 nor may plug 14 rotate about its longitudinal axis. To release plug 14 from body coupler 12 tubular sleeve 18 must be moved towards socket body 16 with sufficient force to overcome compressions spring 18. Locking balls 30 may then roll out of the opening in locking port 20 allowing push head 36 on spiral spring 38 to eject plug 14 from body coupler 12.

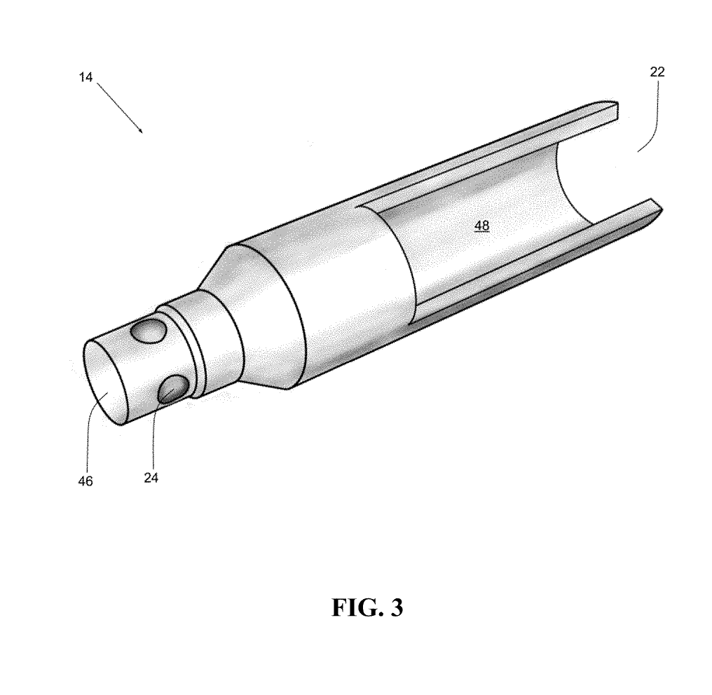

FIG. 3 shows a perspective view of plug 14 with a cutaway to expose cavity 48 leading out through second end 22. The base of the mast is inserted into cavity 48 and held by a friction fit or by adhesive. Proximate to first end 46 and about the diameter of plug 14 are one or more dimples 24.

Thus, there has been shown and described an embodiment of a novel quick-disconnect coupling kit 10 for use by off-road vehicles to attach a mast to the frame of the off-road vehicle. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present invention will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A coupling kit to connect a safety whip mast to an off-road vehicle the coupling kit comprising:
a body coupler being generally cylindrical with a first end adapted to engage a mount attached to an off-road vehicle and second end adapted to engage a plug; and
said plug being generally cylindrical with first end adapted to engage said body coupler and second end adapted to engage said safety whip mast.

2. The coupling kit of claim 1 wherein said first end of said body coupler is a male threaded joint designed to thread into a corresponding female threaded joint of said mount.

3. The coupling kit of claim 1 wherein said first end of said body coupler is a female threaded joint designed to thread into a corresponding male threaded joint of said mount.

4. The coupling kit of claim 1 wherein said second end of said body coupler forms a circular opening, the opening having one or more holes about the diameter of the opening, each hole containing a locking ball within, each hole tapered so that the locking balls may only partially protrude into the opening, and a sleeve about the outside moveable from a first extent to a second extent that when moved to the first extent the locking balls may fully retract from the opening and when moved to the second extent the locking balls partially protrude into the opening.

5. The coupling kit of claim 4 wherein said first end of said plug contains one or more dimples to engage said one or more locking balls.

6. A coupling kit to connect a safety whip mast to an off-road vehicle the combination comprising:
a body coupler being generally cylindrical with a first end adapted to engage a mount attached to an off-road vehicle and second end to engage a plug the second end forming a circular opening, the opening having one or more holes about the diameter of the opening, each hole containing a locking ball within, each hole tapered so that the locking balls may only partially protrude into the opening, and a sleeve about the outside moveable from a first extent to a second extent that when moved to the first extent the locking balls may fully retract from the opening and when moved to the second extent the locking balls partially protrude into the opening;
said plug being generally cylindrical with first end containing one or more dimples to engage said one or more locking balls and a second end containing an opening to engage a safety whip mast.

7. The coupling kit of claim 6 wherein said first end of said body coupler is a male threaded joint designed to thread into a corresponding female threaded joint of said mount.

8. The coupling kit of claim 6 wherein said first end of said body coupler is a female threaded joint designed to thread into a corresponding male threaded joint of said mount.
